(19) United States
(12) Patent Application Publication
(10) Pub. No.: US 2007/0242625 A1
(43) Pub. Date: Oct. 18, 2007

(54) Method and System for a Distributed Wavelength (Lambda) Routed (Dlr) Network

(75) Inventors: John Dunne, Dublin (IE); Tommy Mullane, Dublin (IE); David Drury, Pittsburgh, PA (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: INTUNE TECHNOLOGIES LIMITED, Dublin (IE)

(21) Appl. No.: 11/570,739

(22) PCT Filed: Jun. 17, 2005
(86) PCT No.: PCT/IE05/00069

§ 371 Date: Dec. 15, 2006

(30) Foreign Application Priority Data
Jun. 18, 2004 (IE) S2004/0413

(51) Int. Cl. H04Q 11/00

(52) U.S. Cl. 370/258

(57) ABSTRACT

The invention relates to a method and network for providing an optical fibre wavelength routed network comprising a plurality of nodes on a network ring where each node can drop and add a wavelength, control means to control the wavelength to be transmitted on the network ring, and access means for each node to enable a node to transmit wavelength onto the network ring whereby wavelength collisions with transmit wavelength from other nodes are avoided in the network. The invention describes a network and method having a ring system with a plurality of nodes and an interconnection means to allow information to be communicated between the nodes of the network using packets of data on a wavelength in a novel and efficient manner.

### FIELD OF THE INVENTION

This invention relates to a communications network and method where wavelength routing/switching is used and the routing/switching function is distributed throughout the network and in particular a communications network ring. The network uses optical wavelength division multiplexing for the provision of bandwidth between nodes in the network.

### BACKGROUND OF THE INVENTION

Telecommunications networks have seen rapid advancement over recent years with the advent of Wavelength Division Multiplexing (WDM) where the capacity of a single fibre can be greatly increased. Typically several (4, 16, 32 . . . etc) different wavelengths are used to transmit data from point to point or via a ring (such as SONET) multiplying the data carried by fibre by the number of wavelengths used as each wavelength can carry data independently, typically at 2.5 Gb/s or 10 Gb/s or 40 Gb/s.

There has been considerable research in the area of wavelength routing where different wavelengths can be routed through the network to provide connectivity between multiple nodes without the requirement for an optical to electronic to optical conversion. A system of this type is detailed in US patent number U.S. Pat. No. 6,735,393 assigned to Telenor. Such systems attempt to reduce the cost of networks as optical to electronic conversion incurs considerable cost. The Telenor patent, which is reliant on rigid time slots allocated in the network to transmit data, describes a version of a passively-routed optical network whereby bands of wavelengths are routed to different output paths at each node within a mesh network. However a problem with this US patent is that it does not address the problem of wavelength collisions and how to drop or add wavelengths and bandwidth allocation at nodes to maintain an acceptable Quality of Service (QoS) in the network, which can be a set of single add-drop type nodes on a ring network using wavelength routing. The Telenor patent is all about how to physically connect up the right elements in a mesh network to allow for a wavelength routing network to be constructed including a control plane above the physical layer.

Also in telecommunications networks the type of data that such networks carries has been changing. Traditionally they were used for voice circuits, which require a link to be set up between two points on the network for the duration of the voice call. Since the advent of the internet telecommunications networks now carry data packets from a computer to another computer which has a very different demand requirement. Computer networks generally operate on a packet basis so that the required data is sent without the requirement for a dedicated link to be established for a period of time. Typically Time Division Multiplexing (TDM) access type systems are used for voice networks, which are very inefficient for data networks. Voice data may be converted into packets and transported over the data network provided the data network can guarantee that the packets will reach the destination with low latency. In packet networks routers, for example provided by Cisco, are key systems that route packets over the network along the various paths available. These are typically electronic and may have optical inputs but the routing is performed electronically. A problem with these routers is that they are becoming a bottleneck in an ever increasing data capacity network.

There is a need to provide an optical network and method that can perform routing functions without the requirements of an electronic router and any optical to electronic to optical conversions to overcome the above problems and ensure that the network can operate at maximum efficiency.

### OBJECT OF THE INVENTION

The object of the present invention is to provide a method and network system architecture for the implementation of an optical network which allows access methods and efficient and simple provision of bandwidth between nodes in the network.

### SUMMARY OF THE INVENTION

Accordingly the present invention, as set out in the appended claims, describes a network and method having a ring system with a plurality of nodes and an interconnection means to allow information to be communicated between the nodes of the network using packets of data in a novel and efficient manner. Each node in the network system can access the network in an asynchronous mode, which means that each node may transmit onto the network whenever capacity is available thus improving the overall efficiency of the network. This access scheme is achieved by enabling each node in the network to monitor the traffic on the network before making a decision on how to access the network. To realise this type of access scheme, the traffic on the network is sent through a delay mechanism after the traffic is monitored at each node and before new information is transmitted onto the network.

The present invention also describes a method for wavelength collision avoidance, whereby the network traffic is monitored before it reaches the new transmission point or node in the network, thus the new transmission can be temporarily stopped to avoid a collision on the particular channel being accessed. When the contentious traffic has passed, the transmission that was temporarily stopped can then continue. In an optical system, this means that the same two wavelengths will not appear in any given node at the same time.

Each node may only access one channel on the network at any one time or optionally a node may have multiple wavelength sources to allow the node to access multiple wavelengths/channels at the same time in the same part of the optical fibre causing wavelength collision.

To ensure fairness of access on the network, each receiving node monitors the number of other nodes trying to send information to it. If the receiving node perceives that a plurality of nodes are trying to communicate to it, it can send a push-back signal to some or all of the nodes on the network to tell them to back off from the level of access that they were using at that time in attempting to transmit to the receiving node. This scheme enables capacity in the network to be distributed fairly among the nodes by implementing an algorithm.

Because collisions are managed real time, capacity can be adjusted for demand in a reactionary way rather than trying to foresee it. Each node can look after the management of demand to it by itself so many independent parallel decisions on bandwidth can be made, each wavelength looks after itself on a wavelength basis, because there is no need to take account of two wavelengths appearing at any destination node as an optical filter in the receiver subsystem of the node automatically selects a unique wavelength to drop at that point.

The present invention allows for no need to use a fixed packet length for transmission of data on the network because the network can use an asynchronous access scheme. Each node can therefore make a decision based on traffic profile as to what length packet is suitable over each wavelength transmit. Each receiving node can receive different length packets.

The invention provides packets to be transmitted onto the network to be prioritised in order to ensure a Quality of Service (QOS) to the user of the network. In this case, a lower priority transmission may be temporarily stopped in order to send a higher priority transmission. As the network has an asynchronous access method therefore the prioritisation of packet transmission can take effect as soon as the decision is made and the transmitting node does not have to wait until a time slot, which is a limitation of TDM, becomes available or does not have to wait until a current time slot for the lower priority traffic is ended. Bandwidth allocation and bandwidth reservation are achieved by the invention through a combination of the quality of service function and the inherent statistical performance of the system as opposed to a network-wide bandwidth allocation algorithm whereby specific time slots are used to allocate fixed bandwidth services. This method for bandwidth allocation greatly increases the flexibility of the network to cope with a multitude of traffic profiles and to improve the scalability over time slotted architectures.

The invention provides resilience, recovery and protection on the network is achieved by the use of a dual connection between any two nodes whereby the data going from one node to the next is sent in two directions onto the network. When one network route is disabled, the data may still get to its destination on the other route. This can be implemented by having two fibre channels in the system, one for clockwise communication and another of anticlockwise communications around the ring, if a break in the fibre occurs the other direction can be used to access the node.

The invention provides traffic management and adaptability to traffic type is achieved by varying the mega packet length being transmitted. As the network operates in asynchronous mode the network copes very well with this type of adjustment. This means that virtual sub networks can be set up and work equally well over the same system and support either always on type of connections or smaller mega packets using the same transport means. The underlying transport layer is transparent to data traffic type.

The invention additionally provides for the addition of new nodes seamlessly by inserting the node in the optical fibre path between two other nodes and the ring can then carry on uninterrupted with a new wavelength that is currently not being used in the network assigned to the new node.

Ideally there is provided a control unit associated with each node comprising monitoring means to monitor available wavelength capacity in the network. Preferably the control unit comprises processing means to control wavelength transmit from the node said control is carried out during a delay period introduced by said delay mechanism. Suitably the control unit comprises processing means to decide which wavelength to transmit and configure switching time of the transmission.

In another embodiment the control unit at a first node determines whether transmit wavelengths upstream at a second node in the network are still transmitting comprises means to abort transmit wavelengths from said first node until the transmit wavelengths at said second node is completed. The first node may comprise means to transmit wavelength at different wavelengths to said transmit wavelengths from said second node during the period when said second node is transmitting.

Ideally there is provided means to detect the wavelength being used on the input to any node in the network. Desirably a maintenance channel is added to the network ring by each node.

Desirably a node receiving transmit wavelengths comprising means to detect the number of transmitting nodes trying to communicate with said receiving node and means to determine whether said receiving node is capable of receiving all transmit wavelengths from said transmitting nodes.

Suitably there is provided means to implement a fairness algorithm for bandwidth allocation in the network when said receiving node is incapable of receiving all transmit wavelengths from said transmitting nodes.

A push-back signal may be sent in response to said fairness algorithm from said receiving node to said transmitting nodes. Ideally the push-back signal causes each or some of said transmitting nodes to reduce the amount of time each of said transmitting nodes is trying to access said receiving node.

Preferably the fairness algorithm determines the priority of each of said transmitting nodes and allows the transmitting node with the highest priority transmit first to the receiving node before the transmitting nodes of lower priority in a hierarchical order. Suitably the push-back signal is sent over a dedicated messaging channel wavelength.

In another embodiment of the invention there is provided means for at least one or at each node for implementing a quality of service (QoS) requirement. Preferably decision means are provided at a node to prioritise data to be transmitted onto the network ring over a transmit wavelength from said node to maintain QoS requirements. Ideally during transmit wavelength of data of a particular QoS at a node the invention provides means to abort said data transmit wavelength when said node detects data for transmission at said node having a higher QoS requirement.

Ideally an optical channel monitor is used to detect the wavelengths active on the input to any node.

Suitably a filter means which drops off a small percentage of the transmit wavelength to optically monitor wavelength activity in the ring network.

Preferably tones are used to detect the wavelengths active on the input to any node. The tones, which are present in optical networks, can be used as an effective parameter to detect active wavelengths in the network.

In another embodiment of the present invention the network is configured as a mesh with the routing through the mesh dependent on the wavelength of the light signal. This could be the situation where multiple rings are being interconnected. On the interconnecting nodes some wavelengths will be routed to one ring and other to another. Again each node detects what wavelengths are currently present on a line before adding data to that line and again each node stops sending data on a particular wavelength. If a node further up the line begins using that wavelength, thereby avoiding a collision. This can be expanded so that any connection topology can be used with the routing at the nodes dependent on the wavelength of the light.

In another embodiment a ring of nodes is again present with each node detecting the presence or absence of other wavelengths before choosing a wavelength to send so as to prevent collisions. In this embodiment RF tones are used as an out of band signalling technique to convey information on what wavelengths are currently being used in the ring to prevent collisions. This can be accomplished by tapping off a small amount of signal and doing some simple frequency analysis of the light to determine what RF tones are present. Additionally other information can be conveyed on this out of band control channel so that a separate control channel with dedicated fixed frequency laser is not required.

In another embodiment of the present invention frequency shift keying (FSK) of the optical signals is used as an out of band signalling technique to denote the presence or absence of the wavelength channels in the system and other control information. This control information may be sent prior to a change in wavelength to allow the downstream nodes sufficient time to free the soon to be used wavelength to prevent collisions. In addition the information on the FSK signal may be coding in some fashion. For example by using a PN sequence such as those used in a Code Division Multiple Access (CDMA) network to make detection of the individual signals easier In another embodiment multicasting of the data is accomplished by means of a bypass circuit in each node. This bypass circuit allows data that is received by the node to be routed directly through to the transmitter in the same node in a seamless and low latency manner and sent on to another node that is part of the group of nodes in the multicasting. This allows the multicast signal to be sent to multiple nodes with little extra latency then sending a regular signal.

There is also provided a computer program comprising program instructions for causing a computer program to carry out the above method which may be embodied on a record medium, carrier signal or read-only memory.

### BRIEF DESCRIPTION OF THE DRAWINGS

These and other features of the present invention will be better understood with reference to the following drawings in which:

FIG. 1 is an exemplary embodiment of the invention showing an implementation of a network architecture and a typical node of the network;

FIG. 2 shows an embodiment of the invention with two counter propagating rings;

FIG. 3 shows an implementation of the receiver part of each node;

FIG. 4 shows an implementation of the transmit part of each node.

### DETAILED DESCRIPTION OF THE DRAWINGS

The invention will now be described with reference to exemplary embodiments thereof and it will be appreciated that it is not intended to limit the application or methodology to any specific example. The techniques used by the method of the present invention are specifically provided to enable the formation of an optical network where a plurality of nodes can pass data or other such information between the nodes. This system provides a communications network which can be used for voice, data, multimedia and any other such information to be transmitted or distributed.

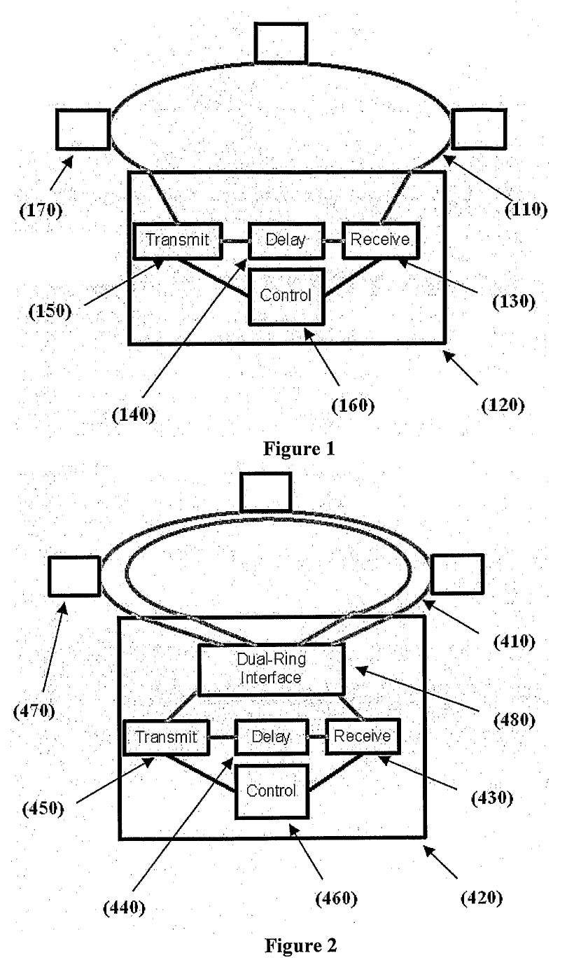

The methodology of the present invention will now be described with reference to FIG. 1 where an optical fibre 110 is used to connect a plurality of nodes 170 in a typical ring network arrangement. One network node is expanded to show its component functionality 120. On the input fibre transmit is processed by the Receive unit 130. This unit receives one specific wavelength (the drop wavelength) and allows all other wavelength to pass trough (Pass wavelengths). The specific received wavelength received data packets from the other nodes in the network. A delay mechanism 140 is implemented between the receive 130 and transmit 150 where the wavelengths the receive unit has allowed through are delayed. This is implemented by means of a length of optical fibre. The transmit unit then adds a new wavelength (Add wavelength) to the ring with data. A control unit 160 is used between the receive 130 and transmit 150 unit to configure the drop and add wavelength.

Another implementation uses two counter propagating rings as in FIG. 2 arranged in an optical fibre dual ring 410. Each ring is similar to the ring shown in FIG. 1 but the light path is propagating transmit wavelength in opposite directions. In this embodiment each node 420, 470 comprises a transmitter 450 and a receiver 430 which are linked through a delay mechanism 440 and all controlled by control unit 560. A dual ring interface 480 allows for transmit wavelengths to be transmitted and received in opposing directions.

Typically there are up to, and above, 100 wavelength channels available as over 40 nm (5 THZ) from 1528 to 1568 nm are available and a wavelength spacing of 0.4 nm (50GHz) can be used. Alternatively 80 nm can be used with a channel spacing of 0.2 nm providing 400 different wavelengths. Even more channels may be used by extending the wavelength range or making the channel spacing smaller.

As each node adds a wavelength to the ring and each node receives one wavelength on the ring, by means of the node selecting the wavelength it can choose which destination node to receive the data modulated on the wavelength, i.e. if node A is configured to receive wavelength x and node B transmits data on wavelength x, any data that node B places on wavelength x will be received by node A, hence a communications channel is set up between the two nodes. This operation is similar for each node on the network, therefore at any one time on the network of N nodes there are N possible connections between nodes. Different wavelengths can be transmitted at the same time at the node. The different wavelengths can be visually represented as a number of colours depending on the wavelength value. If the node can change the wavelength of it's add wavelength it can communicate to different nodes. By use of a switching element where this wavelength can be switched the node can switch between modes and provide a re-configurable network. In this case a packet of data can be sent from one node A to any other node, then the add wavelength can be changed and node A can then send a packet to another node in the network where a packet is a bundle of data with a start and a stop.

The network requires that only one node on the network can add the same wavelength at any one time to avoid wavelength collisions, which will corrupt the data. A collision avoidance scheme according to one aspect of the invention is described below.

An advantage of the present invention is that each node in the network can monitor the number of wavelengths currently used in the network as these are measured in the receiver unit. The control unit 160 continually monitors at a node all the wavelength transmit data in the network and then can then decide which wavelengths are available for access on the network and select an add wavelength for transmit on the network to enable access. As each node operates asynchronously from the other nodes on the network this functionality means that each node can operate independently and monitor the available wavelength independently without the need for central control. The delay between the receive and transmit allows time for detection of the incoming wavelength, processing by the control unit 160 to decide which wavelength to use and switching time to configure the output wavelength.

If a node wishes to access a wavelength and that wavelength is not currently being used, it may do so. However, during the course of a transmission on this wavelength, the node may monitor the appearance of the wavelength from a node upstream. Before the delayed signal interferes with the transmission currently going on, the wavelength is aborted in order to let the upstream wavelength signal pass through. While this is happening, the node can transmit on other wavelengths while waiting for the upstream node to finish transmission, thereby ensuring maximum use of the transmitter in the node.

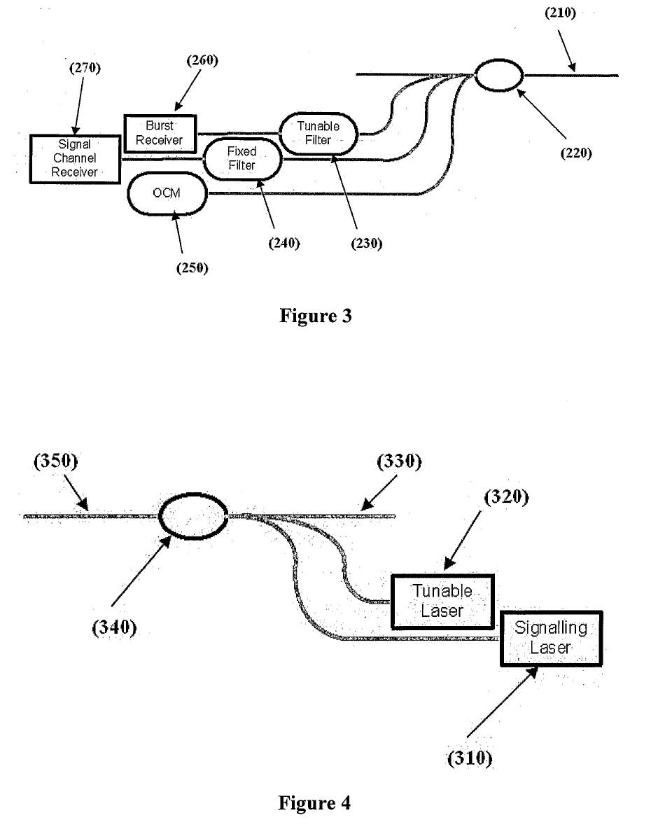

FIG. 3 shows an example of the receiver part of the node where the incoming wavelength come in a fibre 210, a splitter 210 is used to tap part of the signal into the receiver while the rest passes through to the delay. The taps are used for a burst receiver 260 to receive data. A tunable filter is used to detect one wavelength only. A signal channel is received by using a fixed filter 240 and a receiver 270. An optical channel monitor 250 also receives a tap of the signal to determine which wavelengths are active in the network.

It will be appreciated that other arrangements can be used such as a circulator with a grating, thin film reflectors, optical multiplexors and de-multiplexors, arrayed waveguides (AWGs), but not limited thereto.

FIG. 4 shows an example of the transmit part of the node. The optical fibre from the delay element 330 is combined in a combiner 340 with the output of a tunable laser 320 and a signalling laser 310. The tunable laser can use a mach-zendler or other modulator to put data on the output, the signalling laser can use a modulator or direct modulation. It will be also appreciated that other configurations are possible such as a star combiner or coupler, AWG, and other filter elements can be used to combine the output of the tunable laser, signalling laser to the output path of the node.

Signalling channel is used to pass information between nodes. This data can pass push-back data for nodes. Also notification of breaks or lost data and each node can then take appropriate action to use an alternative path. Also configuration information such as when a new node is added to the network. Also it can be used for power normalisation. Each node can notify other nodes when the optical power received is outside a required range and the transmitting node can then either increases or decrease the output of its laser when it is transmitting to that node. In this way the output power of the laser adding the wavelength to the node can compensate for different link losses through the system. In other words if node A transmits to node B and they are adjacent it node A configures is laser to low output power, If node A transmits to node C which is on the opposite side of the ring, it adjusts the laser power up to account for the extra losses. These losses can be made up of other nodes in the network, fibre, connector and splicing losses.

As each node has a signalling laser, which provides a dedicated signal channel they can all operate at different wavelengths but in one embodiment they should all operate at the same wavelength, which is out of the range of wavelength channels used for data transmission. There are examples of two methods of implementing the signalling channels below:
1. Each node uses the signalling channel to send data to the next node in the ring only. It is up to the next node to relay data received to other nodes and around the ring
2. Each node can broadcast to all other nodes by use of the signalling channel and an arbitration scheme is used to allow each node a time to communicate with all other channels, e.g. a round robin, or token method.

It should be noted that other methods exist to implement signalling and the description of methods of implementing signalling is not limited to the description above.

It will be appreciated that numerous system arrangements can be employed to carry out the invention, as will be apparent from the following description. In another embodiment there is provided optical fibre ring network using Wavelength Division Multiplexing (WDM) where each data carrier signal is identified by the wavelength of light used. Each node is connected to the ring so that the fibre goes in through the node and back out onto the ring. Each node transmits data onto the ring using a laser and the laser is tunable to differing wavelengths in the WDM system. Each wavelength will address a different node in the system so that when data is to be sent to a destination node, the wavelength that corresponds to that destination node is stored in a lookup table and the transmitting laser is set to that wavelength before transmission of the data takes place.

Each node has an optical add drop filter which drops a single wavelength from the optical fibre and also drops off a small percentage of the total signal in order to optically monitor the existence of wavelengths on the ring which is performed in a channel monitor. The data is recovered from the dropped optical channel using a burst mode receiver.

This receiver is trained to synchronise itself onto the data in any one burst of data and is capable of adapting its lock-in criteria for each individual burst of data it receives.

The optical channel monitor then passes on information about which wavelengths are currently in-use and which wavelengths are not to a central control unit and scheduler. Each node itself has an electronic interface which can receive packets of data ordered so that the first packet is intended to go out into the network first, the second to go out next and so on. Each packet sent into the node is given a destination node address telling the node where to send the packet.

Packets are placed into queues, with a queue existing for each possible destination node and for each quality of service type (so if there were n nodes and m quality of service types, there would be n×m queues).

According to a scheduler algorithm, and from the information provided by the channel monitor, batches of packets in one queue are sent out onto an available wavelength channel in a mega-packet burst. A preamble data set is placed at the front of this mega-packet, and a termination sentinel is placed at the rear of the this mega-packet.

The transmitting laser is switched to the correct wavelength and the data is modulated onto the laser and sent out onto the ring. If the optical channel monitor detects that another node upstream is sending information on the same wavelength that the transmitter is currently using, then a signal is sent to the transmitter to abort the transmission.

The aborted mega-packet is then terminated with a sentinel which lets the receiving node know that this mega-packet has been aborted. When the optical channel monitor sees that the mega-packet on the ring is ended, it tells the transmitter to resume sending the mega-packet that was aborted. This process is repeated until the mega-packet is fully sent.

The receiving node then receives a series of mega-packets, possibly of different lengths. The receiving node knows from the sentinels attached to the end each mega-packet whether the mega-packet was (a) part of an aborted mega-packet or (b) how many different nodes are attempting to send data to it at the same time.

The receiving node then uses a messaging channel wavelength to send a back-off or push-back signal to all the nodes that are trying to send data to it.

This back-off signal is received by all nodes trying to send data, and each of these nodes then reduces the amount of time it is trying to send data to that receiving node by means of a fairness algorithm. For example, it may back-off by 50% which means that it only tries to access that wavelength 50% of the time that it was previously trying to do this.

Each transmitting node must also have the ability to assess whether there is a mega-packet of higher priority ready to transmit onto the ring. If this is true at any time, then the current transmission can be aborted in a similar manner as described above.

The higher priority mega-packet is then transmitted and when it has been transmitted the node then returns to the lower priority aborted mega-packet and transmits more of that packet. The function of the scheduler is to minimise the length of the queues that it has waiting to be transmitted.

A scheduling algorithm will be used to allow any single node to adapt its scheduling algorithm based on recent history of data traffic type. Adaptive behaviour may include variation of the mega-packet length and variation of how the next transmission wavelength is selected.

A single wavelength laser is also present in the transmitting subsystem of the node. This laser transmits data from one node the next adjacent node on the ring in either direction. The laser is separate from the tunable laser and only transmits supervisory or management signalling data over a dedicated wavelength channel.

For example the laser will use a wavelength outside of the band of wavelengths used in the main WDM system on the ring. Information such as the number of nodes on the network and the lookup table that relates each node to a single wavelength is passed around the network.

Back-off signals are also sent around on this wavelength where possible contention has been found by any one receiving node. For faster back-off signalling, the receiving node may simply address each of the nodes trying to send data to it, using the wavelength of that node in a normal way.

The present invention is self adapting and can be used in different ways by different layer systems and different Network Interface Cards (NICs) within each node. So a family of NIC cards for different applications can all connect into the same physical network and the system adapts itself to manage the bandwidth and changing traffic profiles.

New nodes can be added to the network by first breaking one of the rings and adding in the node and then breaking the other and adding in the node, and in each case, the ring should be able to continue uninterrupted.

By using several of these types of systems configured together, a delivery network for video-on-demand can be created which allows both downstream and upstream communication between a multitude of end-users and a single content server.

It will be appreciated that several of these types of systems configured together to provide a large connection of multiple rings to be created to interconnect banks of computer processors and thus created a larger computer processor with multiple parallel virtual circuits and connections between individual processors.

The embodiments in the invention described with reference to the drawings comprise a computer apparatus and/or processes performed in a computer apparatus. However, the invention also extends to computer programs, particularly computer programs stored on or in a carrier adapted to bring the invention into practice. The program may be in the form of source code, object code, or a code intermediate source and object code, such as in partially compiled form or in any other form suitable for use in the implementation of the method according to the invention. The carrier may comprise a storage medium such as ROM, e.g. CD ROM, or magnetic recording medium, e.g. a floppy disk or hard disk. The carrier may be an electrical or optical signal which may be transmitted via an electrical or an optical cable or by radio or other means.

The invention is not limited to the embodiments hereinbefore described but may be varied in both construction and detail.

The words “comprises/comprising” and the words “having/including” when used herein with reference to the present invention are used to specify the presence of stated features, integers, steps or components but does not preclude the presence or addition of one or more other features, integers, steps, components or groups thereof.

1. An optical fibre wavelength routed network comprising:
a plurality of nodes on a network ring where each node can drop and add a wavelength;
control means to control the wavelength to be transmnitted on the network ring; and
access means for each node to enable a node to transmit wavelength onto the network ring whereby wavelength collisions with transmit wavelength from other nodes are avoided in the network

2. A network as in claim 1 where at least one node operates in an asynchronous mode with at least one or all of the other nodes in the network,

3. A network as claimed in claim 1 wherein each node provides a delay between the detection of active wavelengths on the input to the node and the transmit of wavelengths at the output of the node,

4. A network as claimed in claim 1 wherein each node provides a delay between the detection of active wavelengths on the input to the node and the transmit of waveleniths at the output of the node and the transmit wavelengths are routed through a delay mechanism after being detected at the node and before a decision is made to add a new transmit wavelength to the network

5. A network as claimed in claim 1 wherein there is provided a control unit associated with each node comprising monitoring means to monitor available wavelength capacity in the network.

6. A network as claimed in claim 1 wherein there is provided a control unit associated with each node comprisingg monitoring means to monitor available wavelength capacity in the network and the control unit comprises processing means to control wavelength transmit from the node said control is carried out during a delay period introduced by said delay mechanism.

7. A network as claimed in claim 1 wherein there is provided a control unit associated with each node comprising monitoring means to monitor available wavelength capacity in the network and said control unit comprises processing means to decide which wavelength to transmit and configure switching time of the transmission,

8. A network as claimed in claim 1 wherein there is provided a control unit associated with each node comprising monitoring means to monitor available wavelength capacity in the network and said control unit at a first node determines whether transmit wavelengths upstream at a second node in the network are still transmitting comprises means to abort transmit wavelengths from said first node until the transmit wavelengths at said second node is completed.

9. A network as claimed in claim 8 wherein said first node comprises means to transmit wavelength at different wavelengths to said transmit wavelengths from said second node during the period when said second node is transmitting

10. A network as claimed in claim 1 comprising means to detect the wavelength being used on the input to any node in the network

11. A network as claimed in claim 1 wherein a maintenance channel is added to the network ring for each node.

12. A network as claimed in claim 1 where the output power of a transmit channel to transmit different wavelengths is configured to suit the power loss of the network to a particular destination node.

13. A network as claimed in claim 1 where a tunable laser is used as the transmit wavelength.

14. A network as in claim 1 where a tunable laser is used as the transmit wavelength and the output of the tunable laser is blanked while switching so that any other wavelength channels are not effected by the changing wavelength of the laser.

15. A network as claimed in claim 1 where an array of fixed wavelength lasers are used to generate the add wavelength for each node.

16. A network as clained in claim 1 wherein a node receiving transmit wavelengths comprising means to detect the number of transmitting nodes trying to communicate with said receiving node and means to determnine whether said receiving node is capable of receiving all transmit wavelengths from said transmitting nodes

17. A network as claimned in claim 1 wherein a node receiving transmit wavelengths comprising means to detect the number of transmitting nodes trying to communicate with said receiving node and means to determine whether said receiving node is capable of receiving all transmit wavelengths from said transmitting nodes and means to imnplement a fairness algorithm for bandwidth allocation in the network when said receiving node is incapable of receiving all transmit wavelengths from said transmitting nodes.

18. A network as claimed in claim 16 wherein a push-back signal can be sent in response to said fairness algorithm from said receiving node to said transmitting nodes.

19. A network as claimed in claim 16 wherein a push-back signal can be sent in response to said fairness algorithm from said receiving node to said transmitting nodes and said push-back signal causes each or some of said transmitting nodes to reduce the amount of time each of said transmitting nodes is trying to access said receiving node.

20. A network as claimed in claim 16 wherein a push-back signal can be sent in response to said fairness algorithm from said receiving node to said transmitting nodes said fairness algorithm determines the priority of each of said transmitting nodes and allows the transmitting node with the highest priority transmit first to the receiving node before the transmitting nodes of lower priority in a hierarchical order.

21. A network as claimed in claim 16 wherein a push-back signal can be sent in response to said fairness algorithm from said receiving node to said transmitting nodes and said push-back signal is sent over a dedicated messaging channel wavelength.

22. A network as claimed in claim 1 comprising means for at least one or at each node for implementing a quality of service (QoS) requirement.

23. A network as claimed in claim 1 comprising means for at least one or at each node for implementing a quality of service (QoS) requirement wherein decision mneans are provided at a node to prioritise data to be transmitted onto the network ring over a transmit wavelength from said node to maintain QoS requirements.

24. A network as claimed in claim 1 comprising means for at least one or at each node for implementing a quality of service (QoS) requirement and during transmit wavelength of data of a particular QoS at a node comprising means to abort said data transmit wavelength when said node detects data for transmission at said node having a higher QoS requirement.

25. A network as claimed in claim 1 where an optical channel monitor is used to detect the wavelengths active on the input to any node.

26. A network as claimed in claim 1 where an optical channel monitor is used to detect the wavelengths active on the input to any node further comprising a filter means which drops off a small percentage of the transmit wavelength to optically monitor wavelength activity in the ring network.

27. A network as claimed in claiin 1 where an Array Wave Guides (AWG) and photodiodes are used to detect the wavelengths active on the input to any node.

28. A network as claimed in claim 1 where the presence or absence of Radio Frequency (RF) tones are used to detect the wavelengths active on the input to any node.

29. A network as claimed in a claim 1 where an Frequency shift keyed (FSK) signal, or other out of band signal, is used to convey information on which wavelengths are currently active in the network and transmit other control information.

30. A network as claimed in claim 1 where the add wavelength of any node is not a wavelength detected on the input to the node.

31. A Distributed Wavelenigthi (Lambda) Routed (DLR) network comprising:
a plurality of nodes on a network ring where each node can drop and add a wavelength;
control means to control the wavelength to be transmitted on the network ring; and
access means for each node to enable a node to transmit wavelength onto the network ring whereby wavelength collisions with transmit wavelength from other nodes are avoided in the network.

32. A method of controlling traffic data for wavelength transmit in an optical fibre wavelength routed network comprising the steps of:
providing a plurality of nodes on a network ring where each node can drop and add a wavelength;
controlling the wavelength to be tranismitted on the network ring; and
enabling each node to transmit wavelength onto the network ring whereby
wavelength collisions with transmit wavelength from other nodes are avoided in the network.

33. A method as claimed in claim 32 comprising the further step of operating at least one node in an asynchronous mode with at least one or all of the other nodes in the network.

34. A method as claimed in claim 32 comprising the step of introducing a delay between the detection of active wavelengths on the input to the node and the transmit of wavelengths at the output of the node.

35. A method as claimed in claim 32 comprising the step of introducing a delay between the detection of active wavelengths on the input to the node and the transmit of wavelengths at the output of the node; and routing the transmit wavelength through a delay mechanism after being detected at the node and before a decision is made to add a new transmit wavelength to the network.

36. A method as claimed in claimn 32 comprising the step of monitoring at each node continually the available wavelength capacity in the network.

37. A method as claimed in claim 32 comprising the steps of monitoring at each node continually the available wavelength capacity in the network; and controlling the wavelength transmit from the node during a delay period introduced by said delay mechanism.

38. A method as claimed in claim 32 comprising the steps detecting at a receiving node the number of transmitting nodes trying to communicate with said receiving node and determining whether said receiving node is capable of receiving all transmit wavelengths from said transmitting nodes.

39. A method as claimed in claim 32 comprising the step of implementing a fairness algorithm for bandwidth allocation in the network when said receiving node is incapable of receiving all transmit wavelengths from said transmitting nodes.

40. A method as claimed in claim 39 comprising the step of sending a push-back signal in response to said fairness algorithm from said receiving node to said transmitting nodes.

41. A method as claimed in claim 39 comprising the steps of sending a push-back signal in response to said fairness algorithm from said receiving node to said transmitting nodes; and causing said push-back signal each or some of said transmitting nodes to reduce the amount of time each of said transmitting nodes is trying to access said receiving node.

42. A method as claimed in claim 32 comnprising implementing a quality of service (QoS) requirement means for at least one or each node in the network.

43. A method as claimed in claim 32 comprising implementing a quality of service (QoS) requirement and means for at least one or each node in the network comprising the step of deciding at a node to prioritise data to be transmitted onto the network ring over a transmit wavelength from said node to maintain QoS requiremnents.

44. A computer program comprising program instructions for causing a computer to perform the method of steps of:
providing a plurality of nodes on a network ring where each node can drop and add a wavelength;
controlling the wavelength to be transmitted on the network ring; and
enabling each node to transmit wavelength onto the network ring whereby
wavelength collisions with transmit wavelength from other nodes are avoided in the network.

45. (canceled)

46. (canceled)

47. (canceled)
